(19) United States
(12) Patent Application Publication
(10) Pub. No.: US 2010/0162293 A1
(43) Pub. Date: Jun. 24, 2010

(54) METHOD AND APPARATUS FOR REPLACING A BLACKED OUT PROGRAM IN A SEAMLESS MANNER

(75) Inventors: Todd T. Kassman, Encinitas, CA (US); Hardys Eggum, San Diego, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/342,640

(22) Filed: Dec. 23, 2008

(51) Int. Cl. H04N 7/16; H04N 7/173

(52) U.S. Cl. 725/28; 725/114

(57) ABSTRACT

A method is provided for delivering alternative programming to subscribers. The method includes receiving from a satellite an RF signal in which a first program to be blacked out is carried on a first channel. The method also includes tuning to the first channel and extracting therefrom a first digital transport stream. A replacement program is received in a second digital transport stream. The first and second digital transport streams are decoded to produce first and second video outputs, respectively. The first video output is delivered to subscriber terminals over a content distribution system. When the first program is to be blacked out, the second video output is delivered to the subscriber terminals over the content distribution system instead of the first video output.

### FIELD OF THE INVENTION

The present invention relates generally to the distribution of programming content, and more particularly to a method and apparatus for switching between the distribution of national and regional programming content in a manner that is largely transparent to subscribers.

### BACKGROUND OF THE INVENTION

Video programming is distributed to a wide audience via direct broadcast satellite (DBS) and cable television (CATV) systems. Typically, CATV systems receive their video programming via satellite. Under certain contractual provisions, a specific programming event may be required to be “blacked out” in certain geographic areas. For example, a sports event may be restricted to areas outside of the local market for ticket sales to the live event. Therefore, present video programming delivery systems provide for geographic areas to be selectively blacked out for specific programming events. For example, ESPN usually has to blackout games that are associated with the home markets of the teams. In these geographical areas, the rights to the games may have been sold to a regional network, ad hoc network, or a pay per view service. In order to support these contractual obligations, the cable operator or content provider (e.g., ESPN) offers alternate programming during the blackout, referred to as retune or replacement programming. The satellite receiver at the cable headend, in turn, may make the replacement programming available to subscribers.

Content providers typically provision the replacement programming on an RF channel or feed that is separate from the blacked-out programming. Both channels may be made available in the same RF signal or in different RF signals. Accordingly, when the satellite receiver at the cable headend receives the RF signals from the satellite it will receive the channels that carry both the programming to be blacked out and the replacement programming. When switching from the blacked out programming to the replacement programming, the satellite receiver must retune from one channel to another channel. This retune process causes the viewers to observe a brief interval during which their screens appear black or blank, similar to what the viewer observers when switching channels on their subscriber terminals (e.g., set top terminals). To prevent viewers from observing this disruption, the retuning process is often performed while a locally inserted commercial is being aired. When the viewers are returned to the programming after the commercial, the satellite receiver will be receiving the feed on the new RF channel.

In some cases it would be desirable to perform the channel change on the fly without needing to hide the channel change behind a locally inserted commercial. This requires eliminating the black or blank screen viewers would otherwise observe during the channel change. In this way the content provider and the cable operator can operate in a more flexible manner by performing channel changes that are transparent to viewers whenever they so desire.

### SUMMARY OF THE INVENTION

In accordance with the present invention, a method is provided for delivering alternative programming to subscribers. The method includes receiving from a satellite an RF signal in which a first program to be blacked out is carried on a first channel. The method also includes tuning to the first channel and extracting therefrom a first digital transport stream. A replacement program is received in a second digital transport stream. The first and second digital transport streams are decoded to produce first and second video outputs, respectively. The first video output is delivered to subscriber terminals over a content distribution system. When the first program is to be blacked out, the second video output is delivered to the subscriber terminals over the content distribution system instead of the first video output.

In accordance with another aspect of the invention, a content delivery system headend includes a satellite receiver. The satellite receiver includes an external communication interface having an antenna configured to receive at least one RF signal from a satellite. The RF signal includes a first channel supporting at least a first program to be blacked out. The external communication interface is further configured to receive a replacement program in a second digital transport stream. The satellite receiver further includes a tuner/demodulator for extracting a first digital transport stream from the first channel. In addition, the satellite receiver includes a decoder arrangement for decoding the first and second digital transport streams in parallel with one another to provide a first and second video outputs, respectively. The headend also includes a front end for receiving the first and second video outputs from the decoder arrangement. The front end is configured to process the first and second video outputs for selectively distributing them to subscribers over a content delivery system.

### BRIEF DESCRIPTION OF THE DRAWINGS

FIG. 1 shows one example of a full service satellite program delivery system.

FIG. 2 shows one example of the headend depicted in FIG. 1

FIG. 3 is a block diagram of one example of the satellite receiver shown in FIG. 2.

FIG. 4 shows one example of a method for delivering alternative programming to subscribers.

### DETAILED DESCRIPTION

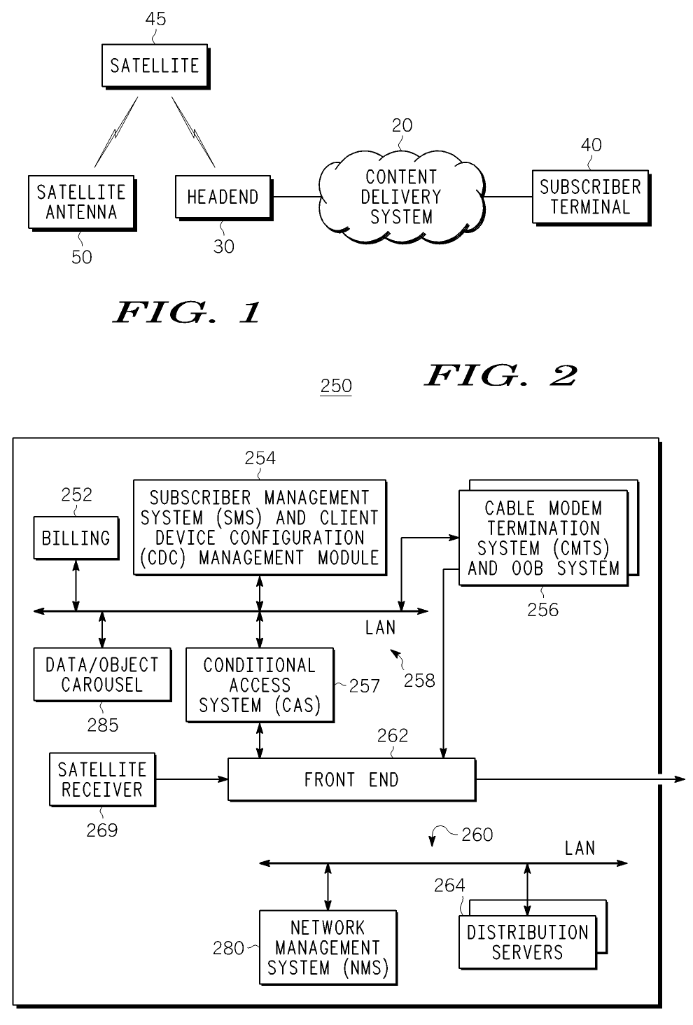

FIG. 1 shows one example of a full service satellite program delivery system. A content provider delivers digital programming content in the form of RF signals from a satellite uplink antenna 50 to a geostationary orbiting satellite 45. The satellite receives the uplinked RF signals and rebroadcasts them to a downlink antenna located in a headend 30. The RF signals received by the headend 30 may be, for example, in a Quadrature Phase Shift Key (QPSK) modulated format in which an encrypted digital (e.g., MPEG-2) transport stream is embedded.

The headend 30 delivers the programming content received from the content provider to subscriber terminals 40 over a content delivery system 20. Illustrative examples of the content delivery system 20 include, but are not limited to, broadcast television networks, cable data networks, xDSL (e.g., ADSL, ADLS2, ADSL2+, VDSL, and VDSL2) systems, satellite television networks and packet-switched networks such as Ethernet networks, and Internet networks. In the case of a cable data network, an all-coaxial or a hybrid-fiber/coax (HFC) network may be employed. The all-coaxial or HFC network generally includes an edge QAM modulator and a hybrid fiber-coax (HFC) network, for example. The edge modulator receives Ethernet frames that encapsulate transport packets, de-capsulate these frames and removes network jitter, implements modulation and, performs frequency up-conversion and transmits radio frequency signals representative of the transport stream packets to end users over the HFC network. In the HFC network, the transport stream is distributed from the headend 30 (e.g., a central office) to a number of second level facilities (distribution hubs). Each hub in turn distributes carriers to a number of fiber nodes. In a typical arrangement, the distribution medium from the headend down to the fiber node level is optical fibers. Subscriber homes are connected to fiber hubs via coaxial cables. In the case of a packet-switched network, any suitable network-level protocol may be employed. While the IP protocol suite is often used, other standard and/or proprietary communication protocols are suitable substitutes.

FIG. 2 shows one example of the headend 30 depicted in FIG. 1. As shown, the headend architecture 250 comprises typical headend components and services including billing module 252, subscriber management system (SMS) and client device configuration (CDC) management module 254, cable-modem termination system (CMTS) and out-of-band (OOB) system 256, network management system (NMS) 280 and data or object carousel 285, as well as LAN(s) 258 and 260 for placing the various components in data communication with one another. It will be appreciated that while a bar or bus LAN topology is illustrated, any number of other arrangements (e.g., ring, star, etc.) may be used. Distribution servers 264, which are coupled to the LAN 260, store objects that are to be downloaded to the subscriber terminals by the data or object carousel 285. A satellite receiver 269 receives RF signals containing programming content from the satellite 45 shown in FIG. 1. The RF signals are generally supplied by various content providers.

The architecture 250 of FIG. 2 further includes a front-end 262 coupled to the content delivery system 20 (via a conditional access system (CAS) 257) in FIG. 1 and the satellite receiver 269. The front end 262 is adapted to “condition” content for transmission over the content delivery system 20. The front end 262 typically includes such components as a multiplexer, encryptor and a modulator. The encryptor encrypts the content delivered to it by the satellite receiver 269 in accordance with techniques determined by the conditional access system (CAS) 257. In a typical distribution network, information is carried across multiple subscriber channels. Typically, the subscriber channels being delivered from the headend 250 to the subscriber terminals (“downstream”) are multiplexed together in the headend. It will also be appreciated that the headend configuration depicted in FIG. 2 is a high-level, conceptual architecture and that each network may have multiple headends deployed using different architectures.

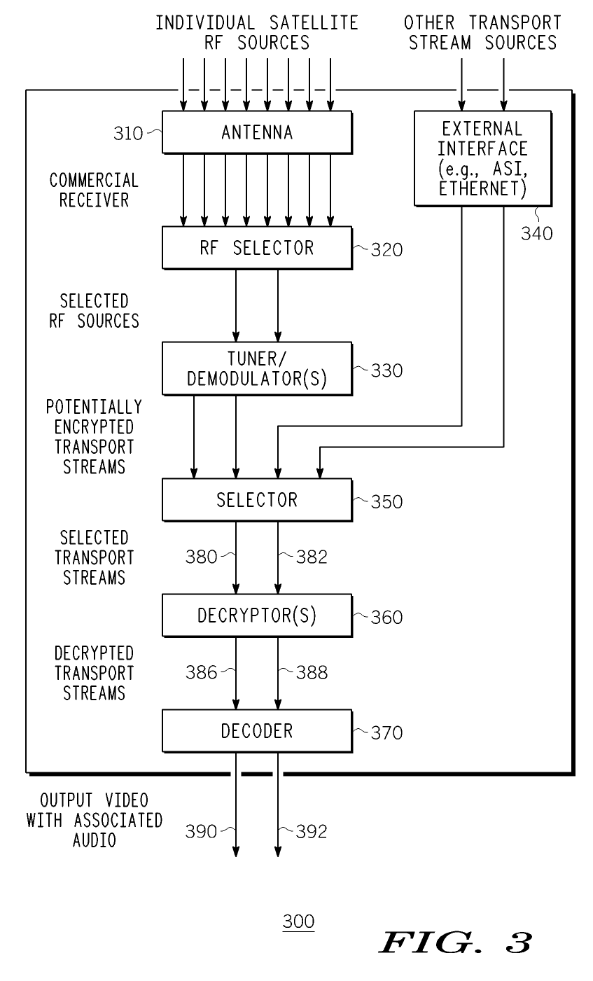

FIG. 3 is a block diagram of one example of the satellite receiver 269 shown in FIG. 2. The satellite receiver 300 of FIG. 3 includes an antenna 310 for receiving the RF signals from one or more satellites such as the satellite 45 shown in FIG. 1. The RF signals received by the antenna 310 are supplied to an N×2 RF switch 320, where N is the number of different RF signals that the satellite receiver is capable of receiving simultaneously. The RF switch 320 selects two of the incoming RF signals and directs them to an in-band tuner/demodulator 330. The in-band tuner/demodulator 330 tunes to one or more selected channels in each RF signal and demodulates the channels to extract a digital transport stream. The digital transport stream may conform to a predetermined media format such as an MPEG format, but may be arranged in accordance with other media formats, including but not limited to other MPEG formats, H.261, or H.263, or H.264, or VC1 formats. In the example of FIG. 3 the tuner/demodulator 330 tunes to two different channels and extracts two corresponding digital transport streams.

The satellite receiver 300 optionally may also include an external network communication interface 340, which supports devices such as modems, streaming media players and other network connection support devices and/or software, coupled through local or wide area networks (not shown) to program providers and providers of other content, such as advertising content. Digital transport streams are received over the interface 340, which may conform to such standards as Ethernet or asynchronous serial interface (ASI), for example.

If the external network communication interface 340 is employed, digital transport streams from the tuner/demodulator 330 and interface 340 are directed to a selector 350, which serves as a switch to select two of the various digital transport streams that it receives. Next, the selected digital transport streams 380 and 382 from the selector 350 are directed to a decryptor 360, which decrypts the content in accordance with well-known encryption/decryption algorithms to thereby provide decrypted digital transport streams 386 and 388.

The decrypted digital transport streams 386 and 388 are received by a decoder arrangement 370. Decoder arrangement 370 includes two separate decoders that can operate in parallel. In this way the decoder arrangement 370 can support two digital transport streams simultaneously. Internal arrangements of decoder arrangement 370 are well known. Each individual decoder may include analog-to-digital converters, one or more storage media and/or buffers, and general or special-purpose processors or application-specific integrated circuits, along with demultiplexors for demultiplexing and/or synchronizing at least two transport streams, for example, video and audio. Video and audio decoders and/or analog and digital decoders may be separate, with communication between separate decoders allowing for synchronization, error correction and control. Suitable commercially available decoder arrangements that are currently available include the Broadcom BCM 7320 and 7400 chipsets.

The decoder arrangement provides two decoded video outputs 390 and 392. Each video output includes a video component and one or more audio components. The second audio component, which is referred to as a second audio program (SAP), is a separate audio channel that may be used for various purposes, such as an alternative soundtrack in a different language.

Decoder arrangements of the type described above which include dual decoders are often used in subscriber terminals such as set top terminals to decode content received from the headend. The dual decoders are typically used to provide picture-in-picture functionality or to view one program on a first channel while recording another program on a second channel. When dual decoders are used in commercial satellite receivers, one decoded program is forwarded to subscriber terminals over the content delivery system and the other decoded program is stored in a storage medium for distribution to subscribers at a later time.

In accordance with the systems and methods described herein, a decoder arrangement that employs dual decoders may be used to perform channel changes in a seamless manner that is transparent to the subscribers. This can be accomplished by using one decoder to decode the program that is currently being delivered to the subscribers by the satellite while the second decoder is used to decode the replacement programming. The replacement program may be received by the satellite receiver from the satellite on a different channel from the first program. Alternatively, the replacement program may be received by the satellite receiver via the external interface 340. When the current program is to be blacked out, the channel change can be performed by simply switching between the decoded programs that are available at the output of the decoder arrangement. That is, instead of performing a retune process, one decoded program is simply switched with another decoded program that is already available. By pre-loading the replacement program in this manner the channel change can be performed so that it is virtually imperceptible to the subscribers. Accordingly, the subscribers can be switched to the replacement programming at any time and not just while a locally inserted commercial is being presented.

As previously mentioned, the replacement program may be a regional program that is to replace a nationally broadcast program. More generally, however, the arrangement and techniques described herein may be used whenever one program is to replace another program. For instance, the replacement program may be a regional or local commercial that is to replace a national commercial. More particularly, the decoded video outputs for both programs are delivered by the satellite receiver to the front end 262 shown in FIG. 2. The front end 262, in turn, conditions the video outputs as necessary before delivering them to the subscriber terminals. For instance, as previously noted, the video outputs may be encrypted in accordance with techniques dictated by the conditional access system (CAS) 257. When the first program is to be blacked out, the front end begins distributing over the content delivery system the video output for the replacement program instead of the video output for the first program. Both programs are delivered to the subscribers on the same subscriber channel.

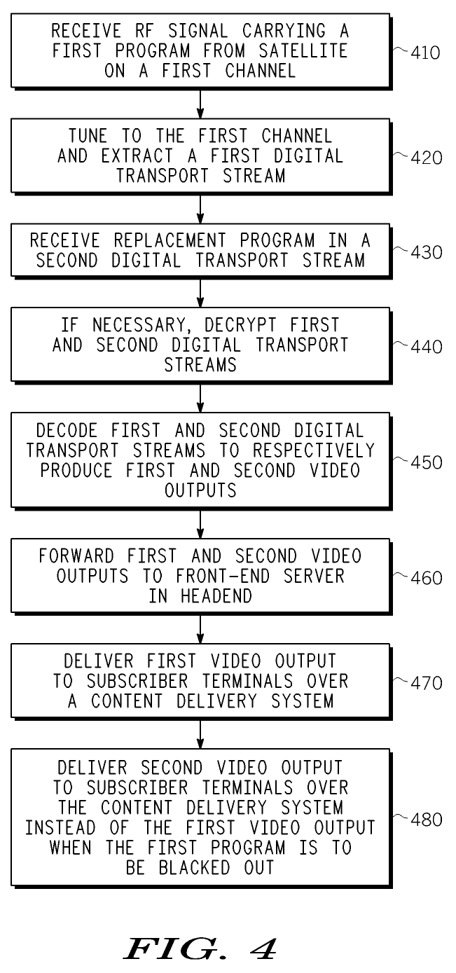

FIG. 4 shows one example of a method for delivering alternative programming to subscribers. The method begins in step 410 when an RF signal is received by a satellite receiver from a satellite on a first channel. The RF signal carries a first program that is to be blacked out. The satellite receiver tunes to the first channel in step 420 and extracts therefrom a first digital transport stream. The satellite receiver also receives, in step 430, a replacement program in a second digital transport stream. If necessary, the first and second digital transport streams are decrypted in step 440. In step 450 the first and second decrypted digital transport streams are decoded to produce first and second video outputs, respectively. The first and second video outputs are forwarded by the satellite receiver in step 460 to an appropriate element or elements in a headend such as a front-end server or the like. The first video output is delivered to subscriber terminals by the front-end server over a content distribution system in step 470. When the first program is to be blacked out, the method continues to step 480, in which the second video output is delivered by the front-end server to the subscriber terminals over the content distribution system instead of the first video output.

The processes described above may be implemented in a general, multi-purpose or single purpose processor. Such a processor will execute instructions, either at the assembly, compiled or machine-level, to perform that process. Those instructions can be written by one of ordinary skill in the art following the descriptions above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, or silicon memory (e.g., removable, non-removable, volatile or non-volatile).

It will furthermore be apparent that other and further forms of the invention, and embodiments other than the specific embodiments described above, may be devised without departing from the spirit and scope of the appended claims and their equivalents, and it is therefore intended that the scope of this invention will only be governed by the following claims and their equivalents.

1. A method for delivering alternative programming to subscribers, comprising:
receiving from a satellite an RF signal in which a first program to be blacked out is carried on a first channel;
tuning to the first channel and extracting therefrom a first digital transport stream;
receiving a replacement program in a second digital transport stream;
decoding the first and second digital transport streams to produce first and second video outputs, respectively;
delivering the first video output to subscriber terminals over a content distribution system; and
when the first program is to be blacked out, delivering the second video output to the subscriber terminals over the content distribution system instead of the first video output.

2. The method of claim 1 wherein the first and second digital transport streams are MPEG streams.

3. The method of claim 1 further comprising decrypting the first and second digital transport streams before they are decoded.

4. The method of claim 1 wherein the first and second video outputs are delivered to the subscriber terminals on a common subscriber channel.

5. The method of claim 1 further comprising encrypting the first and second video outputs in accordance with a conditional access technique associated with the content delivery system prior to delivery over the content distribution system.

6. The method of claim 1 wherein the replacement program is received from the satellite on a second channel and further comprising tuning to the second channel and extracting therefrom the second digital transport stream.

7. The method of claim 1 wherein the second digital transport stream program is received over an interface that conforms to an Ethernet or asynchronous serial interface (ASI) standard.

8. A content delivery system headend, comprising:
a satellite receiver that includes:
an external communication interface that includes an antenna configured to receive at least one RF signal from a satellite, the at least one RF signal including a first channel supporting at least a first program to be blacked out, the external communication interface being further configured to receive a replacement program in a second digital transport stream;
a tuner/demodulator for extracting a first digital transport stream from the first channel;
a decoder arrangement for decoding the first and second digital transport streams in parallel with one another to provide a first and second video outputs, respectively; and
a front end for receiving the first and second video outputs from the decoder arrangement, the front end being configured to process the first and second video outputs for selectively distributing them to subscribers over a content delivery system.

9. The headend of claim 8 wherein the front end is configured to distribute the second video output over the content delivery system instead of the first video output when the first program is to be blacked out.

10. The headend of claim 8 wherein the satellite receiver further comprises a decryptor for decrypting the first and second digital transport streams before they are directed to the decoder.

11. The headend of claim 8 wherein the first and second video outputs are delivered to the subscriber terminals by the front end on a common subscriber channel.

12. The headend of claim 8 wherein the front end further comprises an encoder for encoding the first and second video outputs in accordance with a conditional access technique prior to delivery over the content distribution system.

13. The headend of claim 8 wherein the first and second digital transport streams are MPEG streams.

14. The headend of claim 8 wherein the replacement program is received by the antenna from the satellite on a second channel and wherein the tuner/demodulator tunes to the second channel and extracts therefrom the second digital transport stream.

15. The headend of claim 8 wherein the external communication interface further includes an Ethernet or asynchronous serial interface (ASI) interface through which the second digital transport stream is received.

16. The headend of claim 8 wherein the first program and the replacement program are received by the satellite receiver from a common content provider.

17. At least one computer-readable medium encoded with instructions which, when executed by a processor, performs a method including:
simultaneously receiving from a satellite receiver a first decoded program stream supporting a first program and a second decoded program stream supporting a second program to replace the first program, wherein the first and second programs are supplied by a common content provider;
delivering the first decoded program stream to subscriber terminals over a content distribution system on a first subscriber channel; and
at a specified time, delivering the second program stream to the subscriber terminals over the content distribution system on the first subscriber channel instead of the first program stream.

18. The computer-readable medium of claim 17 further comprising encrypting the first and second program streams in accordance with a conditional access technique associated with the content delivery system before delivering them to the subscriber terminals.

19. The computer-readable medium of claim 17 wherein the specified time denotes a time at which the first program is to be blacked out.
